(19) United States
(12) Patent Application Publication
(10) Pub. No.: US 2010/0270174 A1
(43) Pub. Date: Oct. 28, 2010

(54) BIOSENSOR CELL AND BIOSENSOR ARRAY

(75) Inventors: Xian Tong Chen, Singapore (SG); Han Hua Feng, Singapore (SG); Min Bin Yu, Singapore (SG); Guo Qiang Lo, Singapore (SG)

Correspondence Address: CONNOLLY BOVE LODGE & HUTZ LLP, 1875 EYE STREET, N.W., SUITE 1100, WASHINGTON, DC, 20006, US

(73) Assignee: AGENCY FOR SCIENCE, TECHNOLOGY AND RESEARCH

(21) Appl. No.: 12/161,683

(22) PCT Filed: Jan. 20, 2006
(86) PCT No.: PCT/SG06/00013

§ 371 Date: Jun. 14, 2010

(51) Int. Cl. G01N 27/26; G01N 27/327

(52) U.S. Cl. 205/777.5; 204/403.01; 205/792

(57) ABSTRACT

A biosensor cell (10) and biosensor array comprising a plurality of biosensor cells (10), each biosensor cell (10) comprising a sensing zone. The first sensing electrode (24), a second sensing electrode (25) and the gap (27) separating the sensing electrodes (24,25) are arranged within the sensing zone. The first sensing electrode (24) is electrically insulated from the second sensing electrode (25) by means of the gap (27). Capture molecules (28) are immobilised in the sensing zone; and a field effect transistor (16) having a gate electrode (19), a source electrode (17) and a drain electrode (18); the first sensing electrode (24) being electrically connected to the gate electrode (19) of the field effect transistor (16); and the second sensing electrode (25) being electrically connectable to a gate voltage. The invention also provides a method of detecting a target molecule such as a biomolecule.

The present invention relates generally to bio-molecular electronics, and more particularly to a biosensor cell and a biosensor array that are used for the detection of molecules such as DNA (deoxyribonucleic acid) strands, proteins and any other kinds of analytes.

### BACKGROUND OF THE INVENTION

In the area of biotechnology and medical applications, specialized equipment is typically used for carrying out parallel detection and analysis of specific DNA sequences in a given sample. Important advances in DNA analysis did not appear until the advent of DNA sensors and DNA arrays in the last decade, comprising a plurality of individual DNA sensors. These DNA arrays enable simultaneous detection of multiple DNA sequences to be carried out, thereby reducing analysis time and facilitating automatic sequencing.

However, in order to move these biosensors out of the laboratory into the hands of end-users, devices capable of providing high performance (particularly high sensitivity and selectivity), with high speed, miniaturization, and low cost is needed. In particular, new signal amplification avenues are essential for attaining high sensitivity (down to a few DNA copies) on unamplified samples and in genomic analysis of single cells.

Commercially available state-of-the art DNA microarray chip systems largely rely on optical techniques for DNA detection (see article of Brown et al.: “Review of Techniques for Single Molecule Detection in Biological Application” in NPL Report COAM 2 from 2001). The design of such DNA microarray chip systems pose significant challenges to scaling and automation because of the complexity of integrating together the different components of the system such as the light source, sensor, and photo-detector. Moreover, with optical and other detection techniques, the main limiting factor in developing DNA sensors and DNA arrays is the level of sensitivity of the device (presently achievable sensitivity of optical detection means is estimated to be about 10⁻¹⁵ M, i.e. 10⁻¹⁵ mol/L). Ideally, a biosensor should be capable of detecting trace biomolecules with a detection sensitivity of less than 1,000 molecules (i.e. a sensitivity of about 10⁻²¹ M).

While it is possible to increase the sensitivity of optical sensors by increasing the amount of DNA in a sample via the commonly known technique of polymerase chain reaction (PCR), the procedures for carrying out PCR is unfortunately known to be complicated, expensive, time consuming and contamination-prone, thus increasing the likelihood of introducing error in the amplification process which leads to erroneous results during DNA detection. For this reason, it is desirable to have ultra-sensitive biosensors for DNA which do not require the PCR amplification. Moreover, the avoidance of PCR amplification will also simplify the design and the scaling of automated molecular diagnostic systems, thereby reducing the costs of manufacture.

By avoiding the relatively expensive and complicated optical set-up required in common molecular diagnostic systems and relying instead on electrical detection based on semiconductor technology, electronic readout techniques should in principle allow more robust and easier operation. It can also leverage on the current Very Large Scale Integration (VLSI) semiconductor technology in terms of the scaling of the biosensors and manufacturability. For example, the use of nano-structuring techniques known from semiconductor technology leads to miniaturized formats which offer high sensitivities while keeping production costs low. For these reasons, importance is increasingly attached to the development of electronic biosensors.

Electronic biosensors that have been developed to detect biomolecules electrically can be generally grouped into 3 categories: capacitive biosensors, inductive biosensors and resistive biosensors. A capacitor-based capacitive biosensor is disclosed, for example, in U.S. Pat. No. 5,532,128 A and EP 1 450 156 A1, wherein the capacitance of the capacitor-sensor is altered by when the presence of the target biomolecule. A field effect transistor (FET)-based capacitive biosensor is disclosed, for example, in U.S. Pat. No. 5,466,348 A, wherein biomolecules to be detected are electrically bound and coupled to the gate electrode of the FET, thereby changing the electrical field generating the channel in the FET.

An example of an inductive biosensor is disclosed in US-Patent application US 2002/0164819 A1. Examples of resistive biosensors are disclosed in the U.S. Pat. No. 4,794,089 A, U.S. Pat. No. 5,137,827 A, and U.S. Pat. No. 5,284,748 A, wherein the resistive biosensors comprises an array of sense sites, wherein each sense site comprises two sensing electrodes separated by a gap. A layer of antigen is coated onto a non-conductive base in the gap, and antibody targets bound to conductive nanoparticles can be detected through binding reaction between the layer of antigen and the antibody. In so doing, electrically conductive particles are bound to the base to form aggregates which change the resistance of the sense site.

Further disclosures relating to the use of resistive sensors for DNA selection can be found in the WO 01/00876 A1. The detection of nucleic acid relying on the detection of resistive changes is described by Moller et al. (Langmuir, Vol. 17, p. 54, 265 from 2001). A further development of this method is described in the article by Park et al. in Science, Vol. 295, pp. 1,503 to 1,506 from 2002, in which the discrimination of point mutations (SNPs—single nucleotide polymorphisms) was detected at a sensitivity level that is 10 times higher (i.e. about 10⁻¹³ M) and a specificity level that is 100,000 times higher than that shown in current genomic detection systems.

Braun et al (Nature, Vol. 391 (1998) 775) describes a device for detecting a DNA hybridization event using surface bound oligonucleotides located on two separated electrodes. When a complementary DNA molecule is introduced into the sensor, one end of the DNA molecule becomes bound to the oligonucleotide on one electrode, while the other end is bound to the oligonucleotide on the other electrode. In other words, the DNA molecule is extended between both electrodes, thereby establishing a physical connection between them. In order for a detectable electric current to flow from one electrode to the other via the DNA molecule, positively charged silver ions are bound to the negatively charged DNA molecule, thereby reducing the silver ions to elemental silver. The presence of silver enhances conductivity between electrodes to bring about current flow between the electrodes, thus leading to the detection of the DNA molecule.

Malaquin et al. in Microelectronic Engineering, Vol. 73-74, pp. 887 to 892 from 2004, describes the fabrication of interdigitated nanoelectrodes with a gap of 60 nm and the measurement of the conductance change caused by around 35 gold nanoparticles having a nominal diameter of 100 nm. A typical resistance of approximately 90 GΩ was reported for the gap closed by a single gold nanoparticle. In this case, it is difficult to employ silver enhancement process described in the prior art, e.g., Park et al (supra), in which silver is deposited on Au particles to enhance conductivity between electrodes. As the gap between electrodes is so small, additional metal deposition process such as silver enhancement easily causes shorting between electrodes leading to erroneous signals.

However, metallic nanoparticle based resistive biosensors directly measure detectable properties between electrodes, such as conductance, current, and potential. In the case of nano-gap electrodes which are used to detect a small amount of DNA hybridization events (Malaquin et al. in Microelectronic Engineering, Vol. 73-74, pp. 887 to 892 from 2004), the readout signal is, as mentioned before, so difficult to measure (due to extreme high resistance and low leakage current between electrodes) that complex circuitry is needed to 1) amplify the detected signals; 2) improve the signal to noise ratios; 3) stabilize on-chip voltage and current levels; 4) separate the analog signal ground from the logic device ground; 5) compare and contrast the signals; 6) digitize and reconstruct the signals; 7) compare the signals to values stored in the memory, etc. Detecting such a signal imposes requirements on circuit design and fabrication which makes the construction of dense sense sites extremely complex and practically difficult.

A further problem that has been encountered in biosensors having the layout configuration of multiple, individually addressable sense sites on one substrate (as disclosed in the above mentioned U.S. Pat. No. 4,794,089 A, U.S. Pat. No. 5,137,827 A, and U.S. Pat. No. 5,284,748 A) is the occurrence of “cross-talk” between the different sense sites. When multiple sense sites are made conductive in close proximity to one another, parasitic conductive paths can develop next to the actual sense site. If several neighbouring sense sites are conductive (i.e., the gaps are closed), parasitic parallel paths to ground are produced. These parasitic conductive paths increase the conducted current and distort accurate resistive measurements. This problem cannot be overcome with external electrical circuitry and can become severe when several hundred, or thousand, conductive sense sites are found in close proximity on an array. For this reason, the layout configuration described in the above mentioned U.S. Pat. No. 4,794,089 A, U.S. Pat. No. 5,137,827 A, and U.S. Pat. No. 5,284,748 A is not suitable for detecting large numbers of closely spaced conductive sense sites.

To overcome the problem of “cross-talk” in resistive biosensors, one approach that has been adopted is the use of diodes. The PCT application WO 99/57550 A1 discloses a multiplexed array detection device comprising a diode connected to each sense site. These diodes are used to prevent “cross-talk” between different sense sites and to minimize currents detrimental to the sensitivity of the detection device. However, where nano-gap electrodes are used to detect a small amount of DNA hybridization events (Malaquin et al. in Microelectronic Engineering, Vol. 73-74, pp. 887 to 892 from 2004), the typical resistance for the nanogap that is close-circuited by a few single gold nanoparticles is large—approximately about 1 to about 90 GΩ. Such a high resistance is comparable to the diode junction resistance in the 0.13 μm technology, leading to cross-talk problems. As a result, the layout described in the PCT application WO 99/57550 A1 cannot be, used to overcome the above mentioned “cross-talk” issue of high sensitive DNA biosensors.

Therefore, an object of the present invention is to provide an alternative biosensor that addresses some of the drawbacks of the above-mentioned prior art, in particular to prevent “cross-talk”, as well as to provide high sensitivity at the single molecule level (i.e. a sensitivity at about 10⁻²¹ M), to provide high density (more than 1,000×1,000 sense sites in a sense array), and to simplify the electrical detection circuitry.

### SUMMARY OF THE INVENTION

According to a first aspect of the present invention, a biosensor cell is provided which comprises a substrate having a sensing zone arranged thereon. Arranged within the sensing zone are a first sensing electrode, a second sensing electrode and a gap separating the first sensing electrode from the second sensing electrode. The first sensing electrode is electrically insulated from the second sensing electrode by the gap. Capture molecules are immobilized in the sensing zone. A field effect transistor having a gate electrode, a source electrode and a drain electrode is present in the biosensor cell, the first sensing electrode being electrically connected to the gate electrode of the field effect transistor; and the second sensing electrode being electrically connectable to a gate voltage.

According to a second aspect of the present invention, a biosensor array is provided which comprises a plurality of biosensor cells according to the first aspect of the present invention.

A third aspect of the present invention is directed to a method of detecting a target molecule, the method comprising contacting the biosensor cell according to the first aspect of the invention with a sample that is suspected to contain the target molecules, wherein the binding of the target molecule to any one of said capture molecules measurably alters at least one signal generated by the biosensor. Measurements of the at least one signal is made in order to determine whether said binding of the target molecule to the capture molecule has occurred.

The following comments to the biosensor cell are valid in corresponding form to the biosensor array and method of the invention and vice versa.

The biosensor cell of the present invention provides several advantages, one of which is that low levels of hybridization (if nucleic acids are used as capture and target molecules) or of complex formation (if at least one of the two binding partners is not a nucleic acid, for example, if a nucleic acid binding or a hapten binding antibody is used as capture molecule) can be detected, due to the fact that the structure of the biosensor makes it highly sensitive to small leakage current caused by small amounts of hybridization of target molecules conjugated with electrically conductive particles. Another advantage of the invention is that when the biosensor cell of the present invention is implemented in the form of a biosensor array, it is capable of making thousands of independent measurements across an entire biosensor array, can therefore provide statistically significant readings as to whether hybridization has occurred.

In the context of the present application, the term “capture molecule” generally refers to any molecule that has selective affinity towards a “target molecule”. The term “capture molecule” is used interchangeably with the term “probe”, or probe molecule, while the term “target molecule” is used interchangeably with the term “analyte” or “sample biomolecule”. The term “capture molecule” encompasses, for example, nucleic acids, proteins, carbohydrates, low weight molecular compounds and any other molecule, that exhibits affinity for a target molecule and can form a complex with the target molecule of interest. Examples of nucleic acids include deoxyribonucleic acid (DNA), ribonucleic acid (RNA) or peptide nucleic acid (PNA) molecules. Examples of proteins that can be used as capture molecules include antibodies and fragments thereof, artificial proteins with antibody-like properties (meaning they can be generated to have binding affinity towards a given target) such as, but not limited to, lipocalin muteins as described in Beste et al., Proc. Natl. Acad. Sci. USA 96, 1999, 1898-1903, WO 99/16873, WO 00/75308, WO 03/029471, WO 03/029462, WO 03/029463, WO 2005/019254, WO 2005/019255 or WO 2005/019256, so-called glubodies (see WO 96/23879), proteins based on the ankyrin scaffold (Hryniewicz-Jankowska A et al., Folia Histochem. Cytobiol. 40, 2002, 239-249) or crystalline scaffold (WO 01/04144,). Other examples of proteins that can be used as capture molecules are protein A, avidin, or streptavidin that are commonly used in biochemistry in order to immobilize a target molecule of interest via their specific binding to Fc chains (protein A) or biotin or biotin analogues (avidin, streptavidin). Examples for low weight molecular compounds that are suitable capture molecules are haptens or molecules such as biotin or digoxigenin that are commonly as label due their specific binding to streptavidin and digoxigenin binding antibodies, respectively. Examples of carbohydrates that can be used as capture molecules are lectins. Corresponding target molecules or analytes may be obtained from living organisms as well as molecules obtained from environmental samples. Examples of target molecules include macromolecular biomolecules such as nucleic acids (e.g. a target gene or mRNA transcript), proteins, carbohydrates, peptides, metabolites, other small molecules (for example, chemical pollutants or toxins such as dioxins or DDT) as well as macromolecular biological structures such as entire cells or organisms that carry on their surface target molecules that are bound by the used capture molecule. Other suitable combinations of capture molecules and target molecules that are within the scope of the present invention are, for instance, the examples comprising the method disclosed in PCT applications WO 99/57550 A1, Nature Vol. 391 (1998) 775, Nature Vol. 403 (2000) 635. In order to facilitate complex formation, the target molecule can, for example, also be labelled with a small molecular compound such as biotin or digoxigenin that acts as a ligand for the above-mentioned proteins.

The sensing zone on which capture molecules are arranged refers to any region proximate to the first and the second sensing electrodes on which detection of binding events are detected. Arranged within the sensing zone is a first sensing electrode, a second sensing electrode and a gap separating the electrodes. The target molecule to be analysed may be modified by attachment to an electrically conductive particle. The sensing region is arranged/selected such that when these target molecules are bound to capture molecules within the sensing zone, the electrically conductive particles either comes into direct contact with both sensing electrodes or at least provides a pathway for current flow between the two sensing electrodes. When current (hereinafter “leakage current”) flows between the two electrodes, the gate electrode of the field effect transistor (FET) is charged. This charged state switches on the FET, thus providing a signal indicating positive detection. In this manner, the electrical conductivity between the sensing electrodes is measurably altered when target molecules are bound. This change can be detected by the field effect transistor, and thus allows detection of binding events.

In order for the leakage current between the sensing electrodes to be readily detected via the field effect transistor, the diameter of the electrically conductive particle is preferably chosen to be comparable to the size of the gap between the first sensing electrode and the second sensing electrode, and in particular, between about 10 nm to about 150 nm. In some embodiments, the diameter of the electrically conductively particle is smaller than the width of the gap. If the electrical conductively particle is to have a smaller size than gap, they may be coated with other metallic materials such as silver or gold, etc., to augment or enlarge the size of the electrically conductive particle to short the sensing electrodes.

Target molecules can be located at any position within the sensing region, as long as the electrically conductive particles attached to them are able to connect the first sensing electrode to the second sensing electrode. In one embodiment, capture molecules are immobilized in the gap which separates the two sensing electrodes. Alternatively, or concurrently, the capture molecules are immobilised on a surface of either one or both of the first and/or the second sensing electrodes.

In an alternative embodiment, the target molecule is not modified by the attachment of an electrically conductive particle. After such a target molecule is bound to the capture molecules located within the sensing zone, any reagent that can enhance the conductivity of the target molecule is added. Such a reagent may comprise any metal ion which can be bound to the target molecule, and which can subsequently be reduced to elemental metal in order that an electrical current flows between the sensing electrodes, and the current flow is detected by the field effect transistor. One example of such a reagent comprises silver ions which can be utilised in a silver enhancement process described in Braun et al. (supra).

In order for the detection of a specific target molecule to occur, the capture molecules that are arranged on the biosensor cell preferably has selective affinity with the target molecule suspected to be present in a sample that is being tested. If it is desired to establish reference readings of non-binding events, the biosensor cell may further include capture molecules which do not have any selective affinity with the target molecule, so that ambient signals arising from non-binding events can be measured. These signals are also known as “reference” signals providing an estimated reading of a non-binding event which can be used to distinguish a true signal from a false or inaccurate one.

In another embodiment, the first sensing electrode and the second sensing electrode are comb-shaped, having a plurality of fingers that are facing each other and that are engaged with each other. These fingers of the combs may be arranged in an alternating manner such that a finger of the first sensing electrode is arranged adjacent to a finger of the second sensing electrode, respectively. Each finger may have a width in the range from about 0.1 μm to about 10 μm. Further, the first sensing electrode and the second sensing electrode may be arranged such that the gap between them has a width in the range from several tens of nanometers to several hundred nanometers, or in particular, from about 10 nm to about 150 nm. Alternatively, the first sensing electrode and the second sensing electrode may be comprised in an interdigitated electrode arrangement comprising a plurality of first sensing fingers and a plurality of second sensing fingers arranged in an alternating manner. It should be noted that the first sensing electrode and the second sensing electrode may have any other alternative shape, and are not limited to the comb-shape. For example, the first sensing electrode may comprise a platform on which the second sensing electrode is arranged (hereinafter referred to as “platform arrangement”). The second sensing electrode may comprise a plurality of fingers connected between a first connecting member and a second connecting member; alternatively, the second sensing electrode may comprise fingers arranged in a meandering configuration on the first sensing electrode. In the various platform arrangements, the second sensing electrode comprises a dielectric portion and an electrically conducting portion, and is arranged such that the electrically conducting portion is electrically insulated from the first sensing electrode by the dielectric portion.

The first sensing electrode and/or the second sensing electrode may comprise any electrically conductive material, such as platinum, titanium, copper for example. A presently preferred material is gold, due to its low electrical resistance and stable chemical properties. Similarly, the electrically conductive particle may also be made of gold.

In another embodiment, the biosensor cell further comprises a substrate, wherein the field effect transistor is buried in the substrate. The substrate has a substrate surface which may be covered with a bio-compatible binding layer in the gap between the first sensing electrode and the second sensing electrode, wherein the bio-compatible binding layer is capable of binding the capture molecules to the substrate surface. Examples of a bio-compatible layer which can be used includes Collagen (Types I, III, or V), Chitosan, Heparin, as well as additional components such as Fibronectin, Decorin, Hyaluronic Acid, Chondroitin Sulphate, Heparan Sulphate and growth factors (TGFβ, bFGF). Another example of a biocompatible layer includes amino-silane film, to which thiol-modified DNA oligomers acting as capture molecules can be immobilised via a heterobifunctional cross linking molecule bearing, for example, both thiol- and amino-reactive moieties.

The biosensor cell of invention can be scaled up to carry out large numbers of measurements concurrently on a sample. The scalability of the present biosensor is useful for establishing statistically significant measurements on large sample populations. In accordance with this purpose, the second aspect of the invention is directed to a biosensor array comprising a plurality of biosensor cells. The biosensor cells may be arranged in the biosensor array in the shape of a regular matrix, for example. In one embodiment, the source electrode of the field effect transistor of each biosensor cell is electrically connected to ground; the drain electrode of the field effect transistor of each biosensor cell is electrically connected to corresponding bit lines. Additionally, the first sensing electrode is electrically connectable to gate electrode of the field effect transistor and the second sensing electrode of each biosensor cell is electrically connectable to the gate voltage via corresponding word lines. The gate voltage may comprise a row driver and row address decoder. The biosensor array may further comprise a plurality of signal amplifiers being electrically connected to the corresponding bit lines. The corresponding bit lines and the corresponding word lines may be made of any electrically conductive material, for example, metals chosen from the group consisting of: gold, silver, copper, chromium, and aluminium.

An advantage of the present invention is that a biosensor array is provided which prevents “cross-talk” when multiple biosensor cells are arranged in a dense biosensor array. Further, the amplifying circuits and the addressing circuits for the biosensor array can be extremely simplified while high signal-to-noise ratios and high sensitivity to small amounts of hybridization are provided.

The above mentioned embodiment of the biosensor array may be adapted to give a binary qualitative result indicating whether the target is present in the sample, namely a “Yes or No” result. In another embodiment, the biosensor may be adapted to estimate quantitatively the amount of hybridization event occurring in the biosensor. For this purpose, each biosensor cell may comprise a non-linear electrical component electrically connecting the second sensing electrode with the corresponding word line. Such a non-linear component may be, for example, a diode wherein an AC source, provided for example by a continuous pulse generator, is applied to the second sensing electrode through the diode. The AC source charges the gate capacitor through the conductive path provided by the electrically conductive particles on the target molecules. If the conductivity is high, it will take a shorter time to charge the gate capacitor to such a level that the transistor turns on, due to the fact that the conductivity between electrode gap increases with the amount of hybridization events. Hence, the larger the amount of hybridization or complexation between the target molecules and the capture molecules, the higher the conductivity between sensing electrodes. By measuring the time taken to turn on the field effect transistor in the biosensor, one can roughly estimate quantitatively the amount of hybridization events occurring in the biosensor. Examples of diodes that can be used in this embodiment include zener diodes, varactor diodes and switching diodes.

When deployed for practical use, the biosensor array can be structurally differentiated according to the purpose for which the biosensor array is to be used so as to lower fabrication costs. In one embodiment, the biosensor array is comprised in a sensing chip having a plurality of biosensor cells of the invention, but without any built-in FET and amplifying circuits. These sensing chips can function as mobile chips which can be widely deployed for the collection of live samples (for example, for collecting blood samples from parts of a human population situated in remote areas) and which are subsequently returned to a lab for testing. In order to carry out tests at the lab, a FET sensor module can be connected to the chip to arrive at the biosensor cell as defined in the invention. One advantage in separating the FET from the sensing chip is the reduction in cost per chip since a cheap material e.g. glass, can be used as substrate for sensing chip in stead of Si single crystal. Another advantage is the avoidance of contact between the sample solution and the FET sensor which may potentially result in damage of the FET sensor.

In an alternative embodiment, the biosensor array is comprised in a testing chip having a plurality of biosensor cells of the invention, and having a complete suite of built-in FET/addressing and amplifying circuits. The DNA immobilization/hybridization will be carried out on sensing chip only.

According to the third aspect of the invention, the biosensor cell of the invention can be used for the detection, quantification and qualitative analysis of a variety of target molecules using a corresponding variety of capture molecules. One chief use of the biosensor cell is in the detection of nucleic acid molecules. The target molecule may be derived for example from the human body or an animal. Where it is necessary to determine a particular pathological condition in a human body caused by a viral or bacterial infection, the biosensor cell can be used to detect the presence of nucleic acid sequences belong to for example, the viral or bacterial organism present in a blood sample of the patient. The biosensor cell can also be used for the detection of congenital conditions, e.g. genetic abnormalities or genetic predisposition towards a certain disease, identifiable by the presence of a particular gene. The biosensor can also be used to detect microbial populations from food or natural sources, e.g. sea or river.

In this context, nucleic acid molecules are understood to be for example (longer-chain) DNA molecules and RNA molecules, PNA molecules, cDNA molecules, or else shorter oligonucleotides with, for example, 10 to 50 base pairs (bp), in particular 10 to 30 base pairs. The nucleic acids may be double-stranded, but may also have at least single-stranded areas or be present as single strands for example as a result of preceding thermal denaturing (strand separation) for their detection.

If the present invention is used for the detection of nucleic acid ‘target’ molecules of a predetermined nucleotide sequence, then they are preferably detected in single-stranded form, i.e. they are converted into single strands, if appropriate, prior to the detection, for example by denaturing. In this case, the capture molecules used are nucleic acid molecules having a sequence that is complementary to the single-stranded area. These nucleic acid capture molecules may in turn be nucleic acid molecules having approximately 20 by to approximately 50 by or else have longer nucleotide sequences having up to approximately 500 by or longer, as long as they do not form any intermolecular structures preventing hybridization of the capture molecule to the nucleic acid to be detected.

The use of the biosensor cell makes it possible not just to detect a single type of nucleic acid molecules in an individual measurement series; rather, a plurality of nucleic acid molecules can be detected simultaneously or else successively. For this purpose, a biosensor array in accordance with the second aspect of the invention may be used in conjunction with plurality of types of capture molecules, each of which has a (specific) binding affinity for a specific nucleic acid molecule to be detected, may be bound on the immobilization unit, and/or a plurality of immobilization units may be used, only one type of capture molecule being bound to each of said units.

In one embodiment, the biosensor cell of the invention is used for the detection of an antigen that is caused by the presence of a microbe, e.g. a viral organism such as HIV which causes AIDS, or H5N1 which causes bird flu, in the human body as described for example in U.S. Pat. No. 5,712,385. The capture molecule may comprise an antibody that acts as capture molecule or probe for assaying for the presence and/or amount of the microbe in a given sample. In this context, the term “antibody” is to be understood in the broadest possible sense, but specifically covers monoclonal antibodies, polyclonal antibodies, multispecific antibodies (e.g., bispecific antibodies), and antibody fragments so long as they bind specifically to a target antigen. In order to attach the antibody to a surface of the biosensor cell, the antibody may be directly immobilised onto a biocompatible layer present in the biosensor cell. Alternatively, the antibody maybe modified by incorporating an anchor ligand that exhibits affinity towards the biocompatible layer. Preferably, the antigen molecules are tagged with electrically conductive nanoparticles, most preferably gold nanoparticles, to facilitate the detection of complex formation.

In another embodiment, the biosensor cell is used for specifically and sensitively detecting and quantifying any bacterial or viral organism containing ribosmal RNA, (hereinafter R-RNA), transfer RNA (hereinafter t-RNA) or other RNA, any members or large, intermediate, or small sized categories or taxonomic groups of such organisms; and previously unknown organisms containing R-RNA or t-RNA. The detection of such organisms is described for example in the U.S. Pat. No. 5,723,597. Examples of bacteria which contains RNA that can be detected with the present biosensor cell includes, but is not limited to escherichia coli, chlamydia, salmonella, mycoplasma pneumoniae, eubacteria, legionella, mycobacterium, pseudomonas, and cryptococcus neoformans.

In yet another embodiment, the present invention is used for the detection of a genetic abnormality in a human body. For example, the invention can be used for the prenatal diagnosis of sickle cell anaemia in a foetus at risk of this disease. Briefly, specific beta-globin DNA sequences that is suspected to carry the sickle mutation may be first obtained and labelled with electrically conductive nanoparticles, preferably gold nanoparticles. A synthetic DNA sequence homologous to normal beta A-globin gene sequence can be used as a probe to assay the sample target sequences. The presence of the normal beta A- or abnormal beta S-globin gene sequence can be detected by differences in the signal measured by the biosensor, thereby determining whether the condition is present in the sample.

In summary, the present invention provides a biosensor array which 1) overcomes the “cross-talk” issue between different biosensor cells; 2) achieves high sensitivity' for detecting a small amount of DNA hybridization events; 3) significantly simplifies the circuitry, such as amplifying circuit, addressing circuits, etc.; and 4) improves the signal-to-noise ratio. The present invention can find widespread use in clinical and laboratory processes including mRNA expression analysis; SNP (single nucleotide polymorphism) analysis; re-sequencing; whole genome copy number analysis; DNA-protein interaction; protein-protein interactions; and antibody-antigen identification.

These aspects of the present invention will be more fully understood in view of the following description, drawings and non-limiting examples.

### BRIEF DESCRIPTION OF THE DRAWINGS

In order to understand the present invention and to demonstrate how the present invention may be carried out in practice, preferred embodiments will now be described by way of non-limiting examples only, with reference to the accompanying drawings, in which:

FIG. 1 shows a cross-section through a biosensor cell according to the present invention, wherein a gold nanoparticle bound via target and capture DNA strands provides electrical conductivity between a gate voltage generator and a gate electrode of a field effect transistor;

FIG. 2A shows an ideal equivalent circuit for the biosensor cell, according to the present invention;

FIG. 2B shows a practical equivalent circuit for the biosensor cell according to the present invention;

FIG. 3A is a close-up photograph of nanoscale interdigitated electrodes that can be used in one embodiment of the present invention.

FIG. 3B shows in detail the first and second sensing electrodes of the biosensor cell according to the present invention as used in the biosensor array according to the first embodiment of the present invention;

FIG. 3C-3E shows three other electrode arrangements configured in a platform arrangement.

FIG. 4A shows a graph of Current (A) vs Voltage (V) as measured with conventional biosensors in which the sensing electrodes are directly connected to measuring equipment.

FIG. 4B shows a graph of Current (A) vs Voltage (V) as measured with the biosensor of the invention.

FIG. 5 shows a biosensor array according to a first embodiment of the present invention comprising a plurality of biosensor cells of the present invention arranged in a regular matrix;

FIG. 6 shows a biosensor array according to a second embodiment of the present invention comprising a plurality of biosensor cells of the present invention arranged in a regular matrix, wherein each biosensor cell is electrically connected to each a diode.

### DETAILED DESCRIPTION OF PREFERRED EMBODIMENTS

A cross-section through a biosensor cell 10 according to the present invention is shown in FIG. 1. The biosensor cell 10 comprises a substrate 11. The substrate 11 comprises a layer sequence comprising, successively, a semiconductor layer 12, a first electrically insulating layer 13, and a second electrically insulating layer 14. The layer sequence of the substrate 11 terminates with a substrate surface 15 confining the second electrically insulating layer 14. Silicon (Si) is preferably used to form the semiconductor layer 12, and to use silicon dioxide (SiO₂) as material for the first and second electrically insulating layers 13, 14. Nevertheless, any other suitable semiconductor and electrically insulating materials, respectively, can be used for the layers 12 to 14 in the substrate 11.

A field effect transistor (FET) 16 is buried in the substrate 11, in particular in the semiconductor layer 12 and the first electrically insulating layer 13. The FET 16 comprises source and drain regions 17, 18 arranged in the semiconductor layer 12 and formed by suitable doping of the semiconductor layer 12, and a gate region 19 arranged in the first electrically insulating layer 13 above and laterally between the source and drain regions 17, 18 such that a remainder of the first electrically insulating layer 13 is maintained between the gate region 19 and the semiconductor layer 12 for electrical insulation of the gate region 19. In the present application, the source, drain and gate regions 17, 18, 19 sometimes are also denoted with source, drain and gate electrodes, respectively.

In the semiconductor layer 12, the region between the source and drain regions 17, 18 below the gate region 19 acts as channel region of the FET 16. The source and drain regions 17, 18 are electrically connected via corresponding source and drain connections 21, 23 to respective source and drain track conductors 20, 22. The source and drain track conductors 20, 22 are arranged in the second electrically insulating layer 14, i.e. are also buried in the substrate 11. Therefore, the source and drain connections 21, 23 are extending through the first electrically insulating layer 13. The gate region 19 is electrically connected via a gate connection 26 to a first sensing electrode 24 which is arranged on the substrate surface 15. Therefore, the gate connection 26 extends from the gate region 19 through the first and second electrically insulating layers 13, 14 to the first sensing electrode 24. Further, a second sensing electrode 25 is arranged spaced-apart and electrically insulated from the first sensing electrode 24 on the substrate surface 15. Therefore, a gap 27 exists between the first sensing electrode 24 and the second sensing electrode 25. The gap 27 exposes the substrate surface 15 between the first sensing electrode 24 and the second sensing electrode 25. The second sensing electrode 25 is electrically connected to a predetermined gate voltage generator (not shown) capable of charging the gate region 19 of the FET 16 with a gate voltage V₁₉ in the range from 1 V to 5 V (depending on which technology node implemented), in particular in the range from 0.6 V to 1.5 V. Further details of the first and second sensing electrodes 24, 25 are described below.

It is presently preferred to use gold (Au) as material for the first and second sensing electrodes 24, 25. Nevertheless, any other suitable electrically conducting materials can be used for the first and/or second sensing electrodes 24, 25. Furthermore, an electrically conducting material can be used for the gate connection 26 which may be different to the electrically conducting material used for the first and/or second sensing electrodes 24, 25. The source and drain track conductors 20, 22 and the source and drain connections 21, 23 may comprise any electrically conducting material such as one of the group consisting of: gold (Au), silver (Ag), copper (Cu), chromium (Cr), tungsten (W), and aluminium (Al).

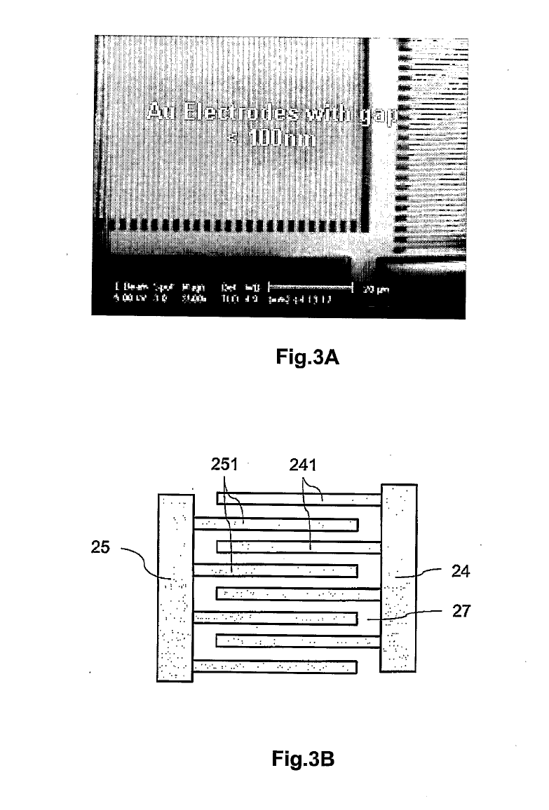

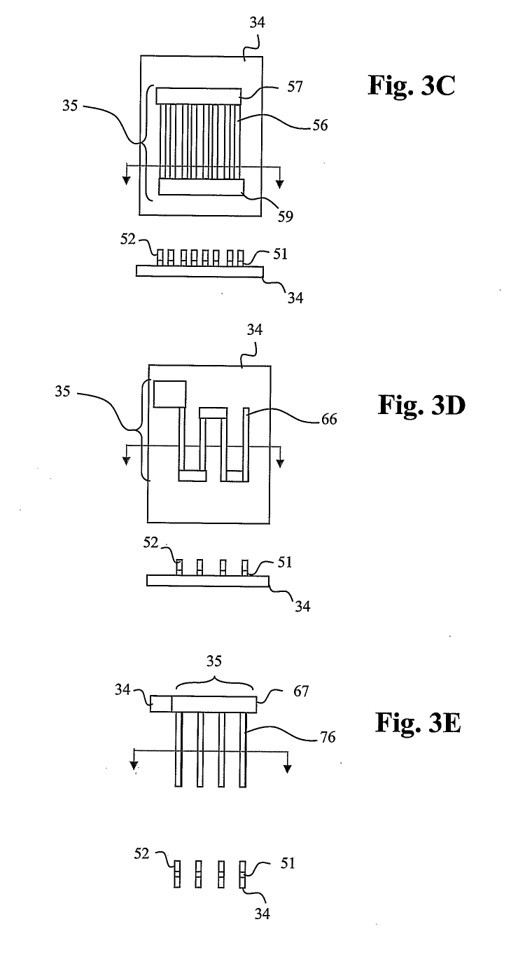

From the top view (as can be seen in FIG. 3B), the first and second sensing electrodes 24, 25 may have any suitable shape. According to the present invention, the first and second sensing electrodes 24, 25 in top view are in the shape of combs and are arranged facing each other, wherein the combs are engaged with each other. Such an electrode arrangement is also known in the art as interdigitated electrodes. In particular, the combs comprise each a plurality of fingers. Each finger of the comb of the first sensing electrode 24 alternates with each a finger of the comb of the second sensing electrode 25. Each finger of the combs of the first and second sensing electrodes 24, 25 may have a width in the range from about 0.1 μm to about 20 μm, in particular in the range from about 0.5 μm to about 10 μm. The gap 27 may have a width in the range from about 10 nm to about 200 nm, in particular in the range from about 30 nm to about 150 nm.

Capture DNA strands 28 acting as capture molecules are immobilized on the substrate surface 15 in the gap 27 between the first and second sensing electrodes 24, 25. If necessary, the capture molecules may be modified with a thiol or amino group, for example, to provide anchorage onto the substrate surface, or onto the biocompatible layer. Capture molecules may be immobilised onto the substrate by dropping a solution containing the biocompatible material with a micropipette and then drying to leave behind an immobilised film comprising the capture molecules. Any other procedure may also be used, including any procedure described in published literature. Briefly, in one example, a gold substrate is immersed in 400 μL of a 1.0-μM solution of probe oligonucleotide in 1.0 M potassium phosphate buffer (pH 7.0) for a specific time period, and subsequently rinsed with 10 mM NaCl, 5 mM TRIS, pH 7.4, (R-BFR) for 5 s; thereafter, the substrate is immersed in 400 μL of 1.0 mM MCH solution in deionised water for 1 h and subsequently rinsed with R-BFR for 5 s, and finally drying under a stream of nitrogen. Prior to immobilization directly onto the substrate surface, the substrate surface may be cleaned with strong acid, e.g. piranha solution (70% sulfuric acid/30% peroxide).

It may be advantageous to provide a bio-compatible binding layer (not shown) in the gap 27 between the first and second sensing electrodes 24, 25 for enhancing immobilization of the capture DNA strands 28. Given a bio-compatible binding layer is provided in the gap 27, the capture DNA strands 28 are immobilized to the substrate surface 15 in the gap 27 via the bio-compatible binding layer.

According to the embodiment of the present invention shown in FIG. 1, target DNA strands 29 acting as target molecules are hybridized to the capture DNA strands 28 for analysis. Each of the target DNA strands 29 has a first end of two ends hybridized to a corresponding capture DNA strand 28 and a second end of the two ends connected to an electrically conductive particle 30. Therefore, the electrically conductive particle 30 is sitting on the gap 27. According to the present invention, the biosensor cell 10 detects the presence of target DNA strands 29 by determining whether the FET 16 is in an on-state or in an off-state. In particular, only if the electrically insulating gap 27 between the first sensing electrode 24 and the second sensing electrode 25 is bridged via an electrically conductive bridge, the state of the FET 16 is changed by charging the gate region 19 of the FET 16 with the gate voltage V₁₉ by means of the predetermined gate voltage generator. The electrically conductive particle 30 represents such an electrically conductive bridge. In other words, if a target DNA strand 29 is hybridized to the capture DNA strand 28, the electrically conductive particle 30 connected to the target DNA strand 29 considerably increases electrical conductivity between the first sensing electrode 24 and the second sensing electrode 25, thereby enabling an electrical current flowing between the predetermined gate voltage generator and the gate region 19 due to the applied gate voltage V₁₉. Therefore, the detection of the state of the FET 16 directly yields information on the presence of target DNA strands 29.

According to one presently preferred embodiment of the present invention, gold (Au) nanoparticles are present in the biosensor as electrically conductive particles 30, and are attached to the target molecules. Each of these gold nanoparticles has a diameter of about 10 nm to about 160 nm. The nanoparticles may ideally be homogeneous in composition or more practically speaking, it has a randomly distributed non-homogeneous composition. Alternatively, the electrically conductive particles 30 may have a core-shell structure in which the core comprises gold (Au) nanoparticles covered with a silver (Ag) or gold (Au) shell.

Ideally, the diameter of electrically conductive particles should be larger than the width of the gap between the sensing electrodes so that the sensing electrodes are automatically bridged once binding occurs. However, under actual circumstances, it may not always be possible to attach such a large particle with the target molecule. In such cases, the diameter of the electrically conductive particle may be smaller than the width of the gap, and in order for detection to occur, the particles may have to be augmented or enlarged by the deposition of a metal layer, e.g., silver or gold, onto the particles such that it reaches a suitable size or conductivity which results in short circuiting of the sensing electrodes as described above (see Braun et al., supra). Apart from shorting the electrodes by enlarging the size of the particles through the deposition of a metal layer (which suffers more risk of generating false signal), the electrodes can also be shorted by increasing the concentration of target molecules in a sample to be tested.

The electrically conductive particle may have a homogeneous structure in such a case, i.e. the composition of the particle is uniform throughout. In such cases, the particles may comprise a core-shell structure, wherein the core comprises the electrically conductive particle which is attached to the target molecule, while the shell comprises the deposited metal layer.

The detection of the presence of target DNA strands 29 in the biosensor cell 10 is preferably based on a change in conductivity of the gap 27, but not on a change in capacitance of the gap 27.

Further, it is pointed out that the materials used for the biosensor cell 10 and described above shall not be understood as limiting, other materials which correspond to the materials mentioned above can be used in like manner. Likewise, other capture molecules than the used capture DNA strands 28, and other target molecules than the used target DNA strands 29, can be used without departing from the scope of the present invention.

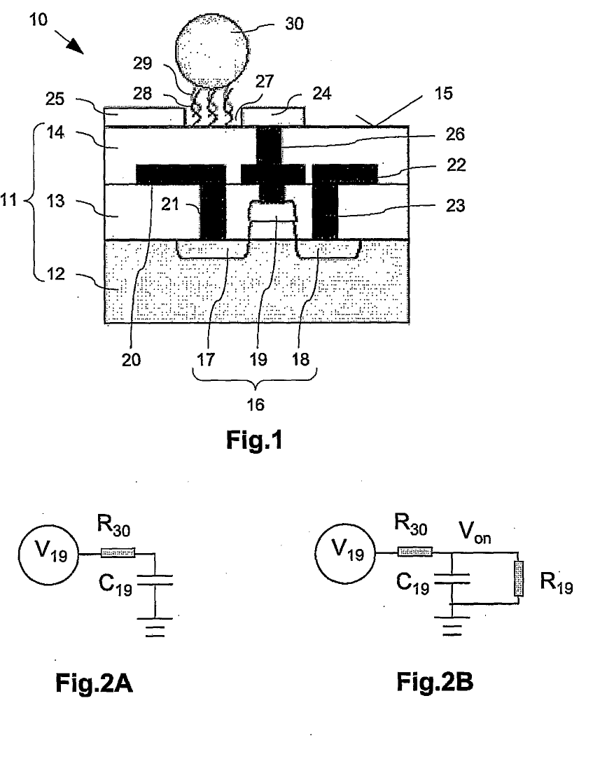

An ideal equivalent circuit for the biosensor cell 10 according to the present invention is shown in FIG. 2A, provided that the gate dielectric layer is a pure insulator. Then, the gate dielectric layer represents a capacitor having a gate capacitance C₁₉. Further, the first and second sensing electrodes 24, 25 are considered to have no resistance. Then, the gate capacitance C₁₉ is charged by the gate voltage V₁₉ via the resistance R₃₀ of the electrically conductive particle 30. In this case, as long as one electrically conductive particle 30 is shorting the first and second sensing electrodes 24, 25, the gate voltage V₁₉ applied to the second sensing electrode 25 will be completely applied to the gate region 19 so that the FET 16 will be turned on.

A practical equivalent circuit for the biosensor cell 10 according to the present invention is shown in FIG. 2B. In addition to the ideal equivalent circuit, the practical equivalent circuit comprises a gate resistance R₁₉ connected in parallel to the gate capacitance C₁₉ since commonly the gate dielectric layer is not a pure electrical insulator, i.e. tiny leakage currents occur through gate dielectric to ground. In particular, if gold nanoparticles are used as electrically conductive particles 30, the typical resistance R₃₀ is about 10¹¹Ω (Malaquin et al. in Microelectronic Engineering, Vol. 73-74, pp. 887 to 892 from 2004) and the gate resistance R₁₉ is about 10¹²Ω. The latter value directly results from Table 51a in ITRS 2001 (International Technology Roadmap for Semiconductors 2001 Edition) and is about 10 times higher than that between the first and second sensing electrodes 24, 25 shorted by one gold nanoparticle. The majority of the gate voltage V₁₉ will still be applied by the predetermined gate voltage generator as FET turn-on voltage Vₒₙ to the gate region 19 causing the FET 16 to turn on. Thus, the present invention significantly simplifies the amplifying circuit and improves the sensitivity and signal-to-noise ratio of the device.

In the following, the limit of detection (LOD), i.e. the minimum number, N, of bound electrically conductive particles 30 necessary for detection to occur, is derived assuming the electrically conductive particles 30 are gold (Au) nanoparticles having a resistance of 90 GΩ/N (i.e. 90 GΩ per nanoparticle). For a 0.13 μm node, the ITRS 2001 provides the data in the following table 1:

TABLE 1

| | | |
|---|---|---|
| | Low Operating | Low Stand-By |
| ITRS 2001 (0.13 μm node) | Power (LOP) | Power (LSTP) |

| | | | | |
|---|---|---|---|---|
| Gate dielectric leakage: | 100 | pA/μm | 1 | pA/μm |
| (current per thickness) | | | | |
| assumed Vₒₙ: | 1 | V | 1 | V |
| (FET turn-on voltage) | | | | |
| applied V₁₉: | 1.5 | V | 1.2 | V |
| (gate voltage) | | | | |

For deriving the limit of detection LOD, it is assumed that the gate width of the FET 16 is 2 μm. Therefore, total gate leakage current is 200 pA and 2 pA respectively, and the gate resistance R₁₉ can be gathered from the above table 1 according to the following equations (1) and (2):

R_{19(LOP)}=1 V/200 pA=5×10⁹Ω, (1)

R_{19(LSTP)}=1 V/2 pA=5×10¹¹Ω. (2)

Further, with respect to the practical equivalent circuit shown in FIG. 2B, the FET turn-on voltage Vₒₙ can be derived according to the following equation (3):

Vₒₙ=V₁₉×R₁₉/(R₃₀+R₁₉). (3)

Since the FET 16 is turned on if the FET turn-on voltage Vₒₙ is at least 1 V (compare table 1), equation (3) can be transformed into the following equations (4) and (5):

1.5R_{19(LOP)}≧R₃₀+R_{19(LOP)}, (4)

1.2R_{19(LSTP)}≧R₃₀+R_{19(LSTP)}. (5)

A further transformation of equations (4) and (5) delivers the following equations (6) and (7):

R_{19(LOP)}≧2×R₃₀=2×90 GΩ/N≈2×10¹¹Ω/N, (6)

R_{19(LSTP)}≧5×R₃₀=5×90 GΩ/N≈5×10¹¹Ω/N. (7)

Inserting equation (1) into equation (6), and equation (2) into equation (7), now delivers the limit of detection LOD, i.e. the minimum number N of gold nanoparticles necessary for detection, according to the following equations (8) and (9):

LOD_{(LOP)}≧200 gold nanoparticles, (8)

LOD_{(LSTP)}≧2 gold nanoparticles. (9)

The limit of detection when using a device operating at low power LOD_{(LOP)} and having 200 gold nanoparticles corresponds to a sensitivity of about 10⁻²¹ M, whereas the limit of detection when using low stand-by power regime LOD_{(LSTP)} of 2 gold nanoparticles corresponds to a sensitivity of about 10⁻²³ M.

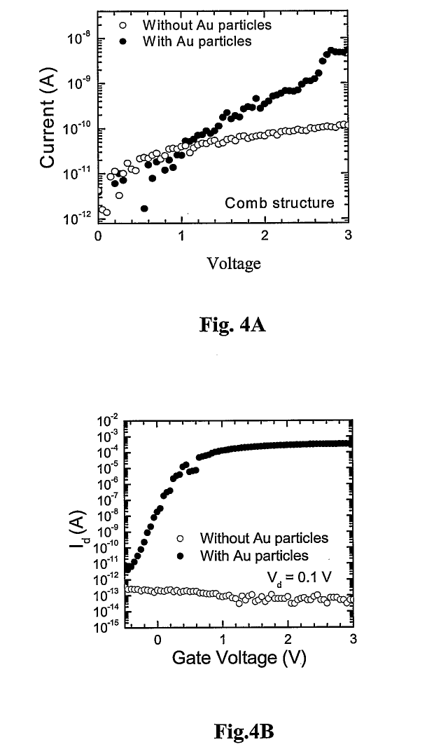

In an attempt to compare the differences between a measurement that is made with conventional biosensor and, the biosensor of the invention, a comparative experiment was carried out. The experimental results are shown below in FIGS. 4A and 4B, respectively. In the conventional biosensor, the Au particle of 100 um and electrode with gap of about 90 nm (FIG. 3A) was used in this experiment. When only a few Au particles were present to electrically short the 1st sensing and 2nd sensing electrode, the measured resistance between electrodes is observed to be very high (˜10¹¹Ω, derived by leakage current of 10⁻¹¹ A at 1V). FIG. 4A shows a graph depicting the value of signals measured using conventional methods. When using conventional methods to measure detectable electrical properties, the signal is sufficiently weak so that no significant difference was seen at 1 V as compared to measurement results from electrodes without Au particles, only 2 order of magnitude seen at 3V (FIG. 4A).

However, when using the present invention, a difference of about 9 orders of magnitude was seen at <1V (FIG. 4B). This result shows that the invention has the ability to detect small numbers of Au particles shorting electrode (provided 90 GΩ/Au particle) and high signal to noise ratio. The FET 16 turns on when a target DNA strand 29 is hybridized to a capture DNA strand 28 and the FET turn-on voltage Vₒₙ is reached or exceeded.

In order to determine whether a signal occurring at the FET 16 is a real signal or a false signal caused by residue/or metallic particles due to, e.g., inappropriate clean process, especially when optimizing protocol, a cell with non-complementary capture DNA may be immobilized as a reference cell which is subject to all treatments as biosensor cells. As target DNA will not hybridize with non-complementary capture DNA and finally be washed away, no electrode shorting will occur. FET in the reference cell should be always in “off” status. This feature ensures that the whole process, especially clean process at various steps during experiments, is properly done. Bio-sensor array only need one reference for signal confirmation/or troubleshooting.

A top view of a biosensor array 100 according to a first embodiment of the present invention is shown in FIG. 5. The biosensor array 100 comprises a plurality of the above described biosensor cells 10 arranged in a regular matrix. Components which have already been described above are denoted herein with identical reference signs, but not described again. Please note that for clarity reasons in FIG. 5 only one biosensor cell 10 is denoted with a circle having a broken line, and with a corresponding reference sign.

The biosensor array 100 according to the first embodiment of the present invention comprises a regular arrangement of 16 biosensor cells 10 of the present invention in a 4×4 matrix, i.e. in a matrix having four rows and four columns. It is pointed out here that the matrix does not need to be a regular matrix. Further, the matrix may comprise any number of rows and columns, and shall not be limited to a 4×4 matrix.

The rows of the matrix are represented by word lines 101 and the columns of the matrix are represented by bit lines 102. Each word line 101 is electrically connected, on the one hand, to one of a plurality of predetermined gate voltage generators 103 and, on the other hand, to the second sensing electrodes 25 of the biosensor cells 10 belonging to the same matrix row. Each bit line 102 is electrically connected, on the one hand, to one of a plurality of detection voltage generators and signal amplifiers 104 and, on the other hand, to the drain regions 17 of the FETs 16 of the biosensor cells 10 belonging to the same matrix column. The source regions 18 of the FETs 16 of all biosensor cells 10 are electrically connected to ground. During operation, if target DNA strands 29 are hybridized at any of the capture DNA strands 28, the FET 16 of the respective biosensor cell 10 is turned on by means of a single square wave signal 105 emitted by the corresponding predetermined gate voltage generator 103 through the word line 101. Therefore, if the detection voltage generator and signal amplifier 104 corresponding to the respective biosensor cell 10 charges this FET 16 through the respective bit line 102, the detection voltage generator and signal amplifier 104 detects the turn-on state of this FET 16 by means of a corresponding signal due to an increased current flow based on the connection to ground, and to amplify this corresponding signal.

As the bit lines 102 are electrically separated from the word lines 101 by means of the FETs 16, the “cross-talk” issue known from the prior art biosensor arrays is successfully overcome in the biosensor array 100 according to the first embodiment of the present invention. Moreover, the outputs of all bit lines 102 can simultaneously provide information on individual biosensor cells 100 corresponding to a single square wave signal 105 applied to the word lines 101, which significantly simplifies the addressing circuit.

The first and second sensing electrodes 24, 25 of the biosensor cell 10 according to the present invention as used in the biosensor array 100 according to the first embodiment of the present invention are shown in detail in FIG. 3B. As already described above, the first and second sensing electrodes 24, 25 can be shaped as combs which face each other. Therefore, the first sensing electrode 24 comprises a plurality of first sensing electrode fingers 241 and the second sensing electrode 25 comprises a plurality of second sensing electrode fingers 251. The first and second sensing electrode fingers 241, 251 engage with each other. In other words, the first sensing electrode fingers 241 and the second sensing electrode fingers 251 alternate with each other in a direction from top to bottom of the drawing plane in FIG. 3B, i.e., adjacent a first sensing electrode finger 241 there is arranged a second sensing electrode finger 251 and vice versa. Due to the comb-like structure of the first and second sensing electrodes 24, 25, the gap 27 meanders between the alternating first and second sensing electrode fingers 241, 251.

Other alternative embodiments having a first and a second sensing electrode 34, 35 of the biosensor cell 10 as used in the biosensor array 100 are shown in detail in FIG. 3C and FIG. 3D. The first sensing electrode 34 comprises a platform on which the second sensing electrode 35 is arranged. From a cross-sectional view taken along the horizontal line across the figure, it can be seen that the second sensing electrode 35 comprises a dielectric portion 51 and an electrically conducting portion 52, and is arranged such that the dielectric portion 51 electrically insulates the electrically conducting portion 52 from the first sensing electrode 34. In FIG. 3C, the second sensing electrode 35 comprises a plurality of fingers 56 connected between a first connecting member 57 and a second connecting member 59. In FIG. 3D, the second sensing electrode 35 comprises a plurality of fingers 66 arranged in a meandering configuration on the first sensing electrode 34. FIG. 3E shows a complex, irregular electrode configuration in which the second sensing electrode 35 comprises a plurality of fingers 76 connected to a finger connector 67. The first sensing electrode 34 is not configured as a platform but is arranged adjacent to the second sensing electrode 35. Similarly, from a cross-sectional view, it can be seen that the second sensing electrode 35 comprises a dielectric portion 51 and an electrically conducting portion 52, and is arranged such that the dielectric portion 51 electrically insulates the electrically conducting portion 52 from the first sensing electrode 34.

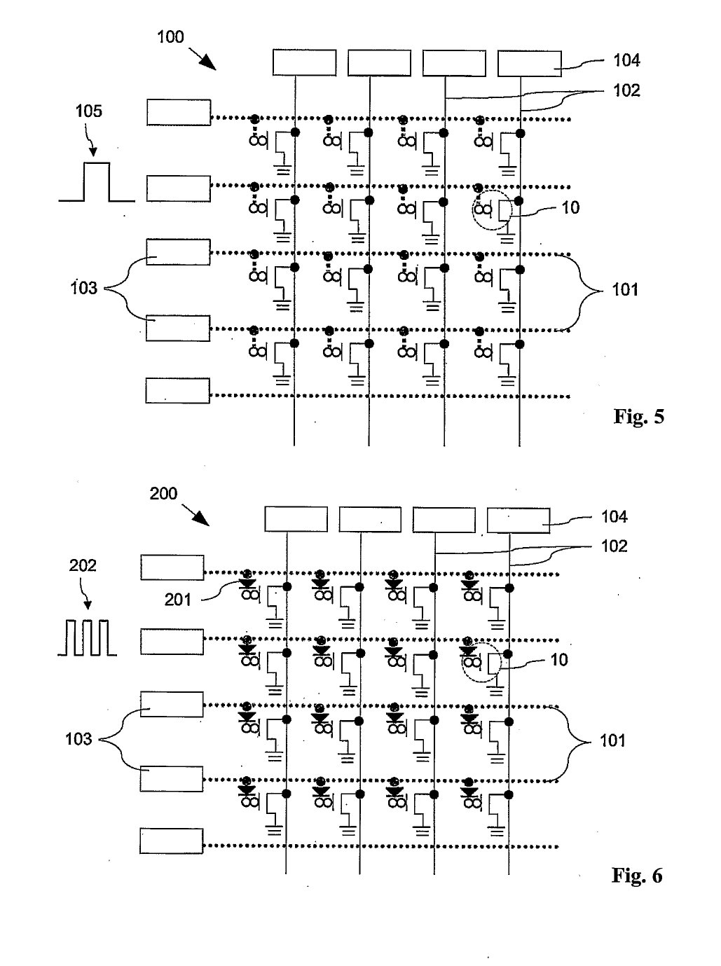

A top view onto a biosensor array 200 according to a second embodiment of the present invention is shown in FIG. 6. The biosensor array 200 according to the second embodiment of the present invention differs from the biosensor array 100 according to the first embodiment of the present invention in that each of the biosensor cells 10 further comprises a diode 201 as a non-linear component. In each of the biosensor cells 10, the diode 201 electrically connects the second sensing electrode 25 and the corresponding word line 101 such that current can flow from the corresponding word line 101 to the gate region 19 of the respective FET 16, but not in opposite direction. Therefore, the gate capacitor can be charged by the corresponding predetermined gate voltage generator 103 through the word line 101, non-linear component 201 and the electrically conductive particle 30 connected to the target DNA strand 29. When the gate capacitor is charged up to >1V, the FET transistor will be turned on. The charge time taken to make FET transistor on is dependent on the conductivity between 1st and 2nd sensing electrodes, which in turn increases with the amount of hybridization events. Therefore, the amount of hybridization events can be quantitatively estimated based on charge time.

In contrast to the biosensor array 100 according to the first embodiment, a multiple square wave signal 202 is applied to the word lines 101 for charging hybridized biosensor cells 10. As the resistance between the first and second sensing electrodes 24, 25 shorted by only one electrically conductive particle 30, as well as the gate capacitor C₁₉, can be predetermined, the amount of hybridization in an individual biosensor cell 10 can be estimated by measuring the level of the current flowing through the corresponding bit line 102 as a function of number of pulses (equivalent to charge time) while applying the multiple square wave signal 202 to the corresponding word line 101.

The FET and auxiliary circuits such as signal amplifying circuits, etc., in biosensor cell 10 of the present invention can be fabricated using any production processes commonly known in semiconductor processing, in particular in CMOS processing. The comb-shaped first and second sensing electrodes 24, 25 can be fabricated by 1) deep ultraviolet lithography patterning of a substrate, 2) sputtering a thin gold film onto the patterned substrate, and 3) lift-off the sputtered thin gold film from the patterned substrate. Each a comb-shaped first sensing electrode 24 and a comb-shaped second sensing electrode 25 form a sensing electrode pair.

After producing a plurality of sensing electrode pairs, wherein each sensing electrode pair is provided for a single biosensor cell 10 of the present invention, the biosensor cells 10 have to be tested with respect to possible shortcuts between the first sensing electrode 24 and the second sensing electrode 25 of the respective sensing electrode pair. This test of the biosensor cells 10 results in approved biosensor cells and in refused biosensor cells, wherein the biosensor cells are refused if a shortcut exists between the fingers of the first sensing electrode 24 and the fingers of the second sensing electrode 25 inside of a sensing electrode pair. Mainly, the yield Yₐ of approved biosensor cells in percent increases with increasing width of the gap 27 between the first sensing electrode 24 and the second sensing electrode 25, whereas the percentage Yᵣ of refused biosensor cells 10 decreases according to the following equation (10):

Yᵣ=100%−Yₐ. (10)

The yield Yₐ of approved biosensor cells in percent depends on the width of the fingers 241, 251 in each sensing electrode pair.

The protocol for immobilizing/hybridizing DNA with capture molecules can be found in published literature, for example, Park et al. (Science, Vol. 295, pp. 1503-1506, 2002). Briefly, prior to the introduction of sample into the biosensor cell, the biosensor cell is first primed by immobilising capture molecules in the gap between the first and the second sensing electrodes. The biosensor cell is then brought into contact with a sample to be examined, preferably a liquid medium such as an electrolyte suspected to contain a target nucleic acid sequence. This is done in such a way that allows the nucleic acid sequence to bind to the capture molecules, i.e. at a temperature below the melting point of the double-stranded hybrid molecules. For the case where the medium contains a plurality of nucleic acids to be detected, the conditions are chosen such that these can bind here in each case at the same time or successively to their corresponding capture molecule in order to form the double-stranded hybrid molecules.

If the target nucleic acid sequence is present in the sample, hybridization with the capture molecule occurs. After non-hybridized nucleic acid molecules are removed from the reaction space by means of a suitable washing step, electrical detection can be carried out. (as electrolyte is conductive, it should be washed away before detection) As mentioned earlier, hybridization results in the FET of the biosensor cell being turned on by means of a single square wave signal emitted by the corresponding predetermined gate voltage generator. The detection voltage generator and signal amplifier detects the “on” state of the FET by means of an increased current flow based on the connection to ground, consequently recording a signal representing the hybridisation event. Further details on the applicable protocol in using the biosensor may be found, for example, in Nucleic Acids Research 1996, Vol. 24, No. 15, 3031-39. by Linda A. Chrisey.

To summarize, the present invention provides a biosensor cell and a biosensor array to excel by:
1. overcoming the “cross-talk” issue for high sensitive biosensor arrays;
2. providing high sensitivity to a small resistance/conductance change caused by small amounts of hybridization of target DNA strands conjugated with electrically conductive particles;
3. extremely simplifying the sensing and amplifying circuits;
4. significantly improving the signal-to-noise ratios; and
5. simplifying the addressing circuits.

Although this invention has been described in terms of preferred embodiments, it has to be understood that numerous variations and modifications may be made, without departing from the spirit and scope of this invention as set out in the following claims.

### LIST OF REFERENCE SIGNS

10 biosensor cell
11 substrate
12 semiconductor layer
13 first electrically insulating layer
14 second electrically insulating layer
15 substrate surface
16 field effect transistor (FET)
17, 18 source and drain regions
19 gate region
20, 22 source and drain track conductors
21, 23 source and drain connections
24 first sensing electrode
241 first sensing electrode finger
25 second sensing electrode
251 second sensing electrode finger
26 gate connection
27 gap
28 capture DNA strand
29 target DNA strand
30 electrically conductive particle
34 first sensing electrode
35 second sensing electrode
51 dielectric portion on second sensing electrode
52 electrically conducting portion on second sensing electrode
56, 66, 76 plurality of fingers
57 first connecting member
59 second connecting member
67 finger connector
V₁₉ gate voltage
R₃₀ particle resistance
C₁₉ gate capacitance
R₁₉ gate resistance
Vₒₙ FET turn-on voltage
100 biosensor array according to first embodiment
101 word line
102 bit line
103 predetermined gate voltage generator
104 detection voltage generator and signal amplifier
105 single square wave signal
200 biosensor array according to second embodiment
201 diode
202 multiple square wave signal

1. A biosensor cell comprising:
a substrate,
a sensing zone arranged on the substrate, said sensing zone having arranged therein a first sensing electrode, a second sensing electrode, and a gap separating the first sensing electrode from the second sensing electrode, said first sensing electrode being electrically insulated from the second sensing electrode by the gap,
capture molecules arranged within the sensing zone,
a field effect transistor comprising a gate electrode, a source electrode and a drain electrode;
the first sensing electrode being electrically connected to the gate electrode of the field effect transistor; and
the second sensing electrode being electrically connectable to a gate voltage.

2. The biosensor cell of claim 1, wherein the capture molecules are immobilized in the gap between the first sensing electrode and the second sensing electrode.

3. The biosensor cell of claim 1, wherein the capture molecules are immobilized on the surface of the first and/or the second sensing electrodes.

4. The biosensor cell of claim 1, wherein the first sensing electrode and the second sensing electrode are comb-shaped, having a plurality of fingers arranged facing each other and that are engaged with each other.

5. The biosensor cell of claim 4, wherein the fingers of the combs are arranged in an alternating manner such that a finger of the first sensing electrode is arranged adjacent to a finger of the second sensing electrode, respectively.

6. The biosensor cell of claim 4, wherein each finger has a width in the range of about 0.1 μm to about 20 μm.

7. The biosensor cell of claim 4, wherein the first sensing electrode and the second sensing electrode are arranged such that the gap has a width in the range from 1 nm to 10 um.

8. The biosensor cell of claim 7, wherein the gap has a width of between about 10 nm and about 150 nm.

9. The biosensor of claim 1, wherein the first sensing electrode and the second sensing electrode are comprised in an interdigitated electrode arrangement comprising a plurality of first sensing electrodes and second sensing electrodes arranged in an alternating manner.

10. The biosensor of claim 1, wherein the first sensing electrode comprises a platform, the second sensing electrode being arranged on the first sensing electrode.

11. The biosensor of claim 10, wherein the second sensing electrode comprises a dielectric portion and an electrically conducting portion, said second sensing electrode being arranged such that the electrically conducting portion is electrically insulated from the first sensing electrode by the dielectric portion.

12. The biosensor of claim 11, wherein the second sensing electrode comprises a plurality of fingers connected between a first connecting member and a second connecting member.

13. The biosensor of claim 11, wherein the second sensing electrode comprises a plurality of fingers arranged in a meandering configuration on the first sensing electrode.

14. The biosensor cell of claim 1, wherein the capture molecules have selective affinity with a target molecule suspected to be present in a sample to be tested.

15. The biosensor cell of claim 1, further comprising capture molecules which do not have selective affinity with the target molecule suspected to be present in the sample to be tested.

16. The biosensor cell of claim 1, further comprising target molecules at least partially complexed with the capture molecules having selective affinity with the target molecules, each target molecule being bound to an electrically conductive particle, wherein the electrically conductive particles provide an electrically conductive path between the first sensing electrode and the second sensing electrode, thereby enabling a current flow between the first sensing electrode and the second sensing electrode, and thereby charging the gate electrode of the field effect transistor.

17. The biosensor cell of claim 16, wherein the electrically conductive particle comprises a metal selected from the group consisting of gold, silver, copper and alloys thereof.

18. The biosensor cell of claim 17, wherein the electrically conductive particle has a diameter in the range of about 10 nm to about 100 nm.

19. The biosensor cell of claim 18, wherein the electrically conductive particle has a diameter larger than the width of the gap separating the first sensing electrode from the second sensing electrode.

20. The biosensor cell of claim 19, wherein the electrically conductive particle has a homogeneous structure.

21. The biosensor cell of claim 19, wherein the electrically conductive particle comprises a core surrounded by a shell.

22. The biosensor cell of claim 1, wherein the substrate has a surface covered with a bio-compatible binding layer, the bio-compatible binding layer being capable of binding the capture molecules to the substrate surface.

23. The biosensor of claim 1, wherein the first sensing electrode and the second sensing electrode each has a surface covered with a bio-compatible layer.

24. The biosensor cell of claim 1, wherein the field effect transistor is buried in the substrate.

25. The biosensor cell of claim 1, wherein the field effect transistor comprises a metal oxide field effect transistor.

26. A biosensor array comprising a plurality of biosensor cells according to claim 1.

27. The biosensor array of claim 26, wherein the biosensor cells are arranged in a regular matrix.

28. The biosensor array of claim 27, wherein the source electrode of the field effect transistor of each biosensor cell is electrically connected to ground, wherein the drain electrode of the field effect transistor of each biosensor cell is electrically connected to corresponding bit lines, and wherein the second sensing electrode of each biosensor cell is electrically connectable to the gate voltage via corresponding word lines.

29. The biosensor array of claim 28, further comprising a plurality of signal amplifiers being electrically connected to the corresponding bit lines.

30. The biosensor array of claim 26, wherein each biosensor cell comprises a non-linear component electrically connecting the second sensing electrode and the corresponding word line to quantitatively estimate amount of hybridization events.

31. The biosensor array of claim 30, wherein the non-linear component is a diode.

32. A method of detecting a target molecule, wherein the method comprises:
contacting a biosensor cell as defined in claim 1, with a sample that is suspected to contain the target molecule suspected to be present in a sample, wherein the binding of the target molecule to any one of said capture molecules measurably alters a signal generated by the biosensor, and
measuring at least one signal generated by the biosensor cell to determine whether binding of the target molecule to the capture molecule has occurred.

33. The method of claim 32, wherein measuring at least one signal generated by the biosensor comprises:
carrying out a first electrical measurement prior to contacting the biosensor cell with the sample,
carrying out a second electrical measurement after contacting the biosensor cell with the sample, and
comparing the first electrical measurement to the second electrical measurement to determine whether the first electrical measurement has been altered.

34. The method of claim 33, wherein carrying out the first and/or second electrical measurement comprises measuring transistor current, said transistor current being a function of at least one of voltage potential, capacitance, electrical resistance, the electrical current flow or the electrical potential between the first and/or the second sensing electrode.

35. The method of claim 32, further comprising contacting a reference biosensor cell according to claim 15 with the sample, thereby producing a reference signal.

36. The method of claim 35, further comprising comparing the second electrical measurement with the reference signal generated from the reference cell to determine whether hybridization event of target molecule with capture molecule has occurred.

37. The method of claim 32, further comprising correlating said at least one signal generated by the biosensor to the presence of the target molecule in the sample.

38. The method of claim 32, wherein at least one capture molecule is selected from the group consisting of a nucleic acid molecule a protein, a carbohydrate, a low molecular weight chemical compound, and mixtures thereof.

39. The method of claim 38, wherein said nucleic acid molecule is selected from the group consisting of a single stranded DNA molecule, a RNA molecule, and a PNA molecule.

40. The method of claim 39, wherein the DNA molecule is a gene or a gene fragment.

41. The method of claim 39, wherein the RNA molecule is an mRNA transcript.

42. The method of claim 38, wherein the protein is selected from the group consisting of an antibody, an antibody fragment, a protein with antibody-like properties, streptavidin, avidin and protein A.

43. The method of claim 32, wherein the target molecule is selected from the group consisting of a nucleic acid molecule, a protein, a carbohydrate, a peptide, a metabolite, and a biological cell.

44. The method of claim 43, wherein the nucleic acid sequence is selected from the group consisting of DNA molecules, RNA molecules, and oligonucleotides having between 10 to 50 base pairs (bp).

45. The method of claim 32, wherein the target molecule is labelled with gold nanoparticles.

46. The method of claim 32, wherein the target molecule is conjugated with a label selected from the group consisting of biotin, digoxigenin, fluorescein, and rhodamine.

47. The method of claim 32, further comprising adding a reagent for enhancing the electrical conductivity of the target molecule, said reagent being capable of binding to the target molecule.

48. The method of claim 47, wherein the reagent comprises reducible metal ions.

49. The method of claim 47, wherein the metal ions are reduced to elemental metal upon binding with the target molecule.
